(19) United States
(12) Patent Application Publication
(10) Pub. No.: US 2023/0055783 A1
(43) Pub. Date: Feb. 23, 2023

(54) 3D BOUNDING BOX RECONSTRUCTION METHOD, 3D BOUNDING BOX RECONSTRUCTION SYSTEM AND NON-TRANSITORY COMPUTER READABLE MEDIUM

(71) Applicant: INSTITUTE FOR INFORMATION INDUSTRY, Taipei City (TW)

(72) Inventors: Wen Kai LIU, Taipei City (TW); Yu-Sheng TSENG, Taipei City (TW); Dmitrii MATVEICHEV, Taipei City (TW); Daw-Tung LIN, Taipei City (TW)

(73) Assignee: INSTITUTE FOR INFORMATION INDUSTRY, Taipei City (TW)

(21) Appl. No.: 17/489,599

(22) Filed: Sep. 29, 2021

(30) Foreign Application Priority Data
Aug. 20, 2021 (TW) 110130954

(51) Int. Cl. G06T 7/246; G06K 9/46; G06K 9/00

(52) U.S. Cl. CPC G06T 7/248; G06T 7/251; G06K 9/4604; G06K 9/00785; G06K 9/00208; G06T 2207/30241; G06T 2207/30236

(57) ABSTRACT

A 3D bounding box reconstruction method includes obtaining masks corresponding to a target object in images, obtaining a trajectory direction of the target object according to the masks, generating a target contour according to one of the masks, transforming the target contour into a transformed contour using a transformation matrix, obtaining a first bounding box according to the transformed contour and the trajectory direction, transforming the first bounding box into a second bounding box corresponding to the target contour using the transformation matrix, obtaining first reference points according to the target contour and the second bounding box, transforming the first reference points into second reference points using the transformation matrix, obtaining a third bounding box using the second reference points, transforming the third bounding box into a fourth bounding box using the transformation matrix, and obtaining a 3D bounding box using the second bounding box and the fourth bounding box.

### CROSS-REFERENCE TO RELATED APPLICATIONS

This non-provisional application claims priority under 35 U.S.C. § 119(a) on Patent Application No(s). 110130954 filed in Taiwan (R.O.C.) on Aug. 20, 2021, the entire contents of which are hereby incorporated by reference.

### BACKGROUND

### 1. Technical Field

This disclosure relates to a bounding box reconstruction method, and particularly to a 3D bounding box reconstruction method.

### 2. Related Art

Due to the widespread use of vehicles, the issue of vehicle safety is getting more and more attention, and accordingly, there are more surveillance cameras installed at traffic intersections. However, with the increase in the number of surveillance cameras, it is difficult to monitor each camera manually, so various automated methods such as vehicle detection, traffic flow calculation, vehicle tracking, license plate recognition, etc. have been developed to be implemented on cameras in recent years.

Most of these automated methods involve computations based on the bounding box corresponding to the vehicle in the camera image. However, the existing bounding box reconstruction methods are limited by the conditions in which: (1) the road environment must be composed of vertical lines and horizontal lines; (2) the vehicle movement only includes linear motion; (3) the direction of traffic flow is the same as the lane direction. Therefore, the existing bounding box reconstruction methods can only be applied to the road environment with a fixed trajectory direction.

### SUMMARY

Accordingly, this disclosure provides a 3D bounding box reconstruction method, a 3D bounding box reconstruction system and a non-transitory computer readable medium that are applicable to complex road environments, such as intersections, roundabouts, etc.

According to an embodiment of this disclosure, a 3D bounding box reconstruction method includes obtaining masks corresponding to a target object in images, obtaining a trajectory direction of the target object according to the masks, generating a target contour according to one of the masks, transforming the target contour into a transformed contour using a transformation matrix, obtaining a first bounding box according to the transformed contour and the trajectory direction, transforming the first bounding box into a second bounding box that corresponds to the target contour using the transformation matrix, obtaining first reference points according to the target contour and the second bounding box, transforming the first reference points into second reference points using the transformation matrix, obtaining a third bounding box using the second reference points, transforming the third bounding box into a fourth bounding box using the transformation matrix, and obtaining a 3D bounding box using the second bounding box and the fourth bounding box.

According to an embodiment of this disclosure, a 3D bounding box reconstruction system includes an image input device, a storage device and a processing device coupled to the processing device and the storage device. The image input device is configured to receive images. The storage device stores a transformation matrix. The processing device is configured to perform a number of steps including: obtaining masks corresponding to a target object in images; obtaining a trajectory direction of the target object according to the masks; generating a target contour according to one of the masks; transforming the target contour into a transformed contour using the transformation matrix; obtaining a first bounding box according to the transformed contour and the trajectory direction, and transforming the first bounding box into a second bounding box using the transformation matrix, wherein the second bounding box corresponds to the target contour; obtaining first reference points according to the target contour and the second bounding box, and transforming the first reference points into second reference points using the transformation matrix; obtaining a third bounding box using the second reference points, and transforming the third bounding box into a fourth bounding box using the transformation matrix; and obtaining a 3D bounding box using the second bounding box and the fourth bounding box.

According to an embodiment of this disclosure, a non-transitory computer readable medium includes, at least one computer executable procedure, wherein a number of steps are performed when said at least one computer executable procedure is executed by a processor, and the steps include: obtaining masks corresponding to a target object in images; obtaining a trajectory direction of the target object according to the masks; generating a target contour according to one of the masks; transforming the target contour into a transformed contour using a transformation matrix; obtaining a first bounding box according to the transformed contour and the trajectory direction, and transforming the first bounding box into a second bounding box using the transformation matrix, wherein the second bounding box corresponds to the target contour; obtaining first reference points according to the target contour and the second bounding box, and transforming the first reference points into second reference points using the transformation matrix; obtaining a third bounding box using the second reference points, and transforming the third bounding box into a fourth bounding box using the transformation matrix; and obtaining a 3D bounding box using the second bounding box and the fourth bounding box.

In view of the above description, the 3D bounding box reconstruction system, the 3D bounding box reconstruction method and the non-transitory computer readable medium in this disclosure may reconstruct a 3D bounding box of a target object for correcting the position of the center of the target object so as to obtain a more accurate target object trajectory direction. The system, method and non-transitory computer readable medium in this disclosure may be applied to vehicle monitoring, achieve 3D reconstruction of traffic flows in different direction, and overcome the limitations of the existing methods.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a function block diagram of a 3D bounding box reconstruction system according to an embodiment of this disclosure;

FIG. 2 is a schematic diagram of image transformation according to an embodiment of this disclosure;

FIG. 3 is a flow chart of a 3D bounding box reconstruction method according to an embodiment of this disclosure;

FIGS. 4A and 4B are schematic diagrams of the computation of a 3D bounding box reconstruction method according to an embodiment of this disclosure; and

FIGS. 5A and 5B are schematic diagrams of the application of a 3D bounding box reconstruction method according to an embodiment of this disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

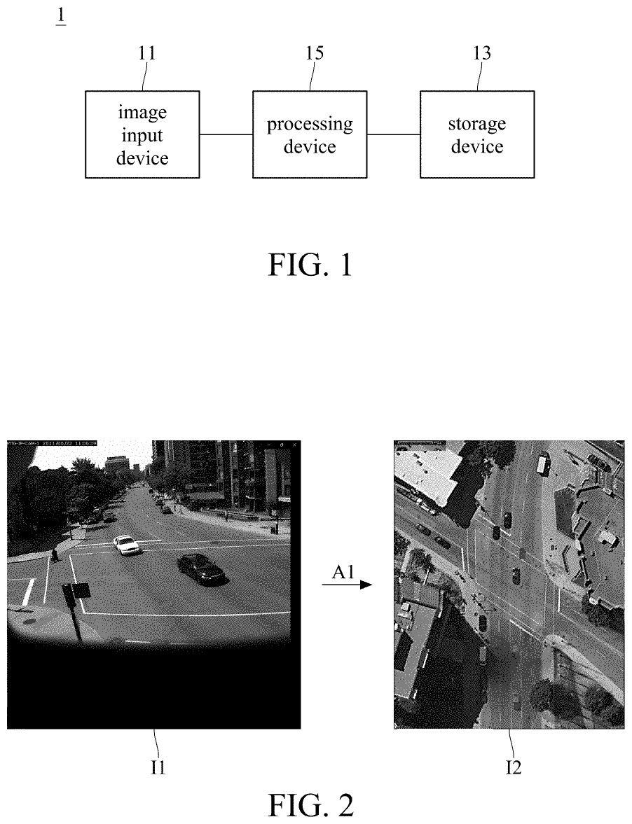

Please refer to FIG. 1, a function block diagram of a 3D bounding box reconstruction system according to an embodiment of this disclosure. The 3D bounding box reconstruction system 1 may reconstruct 3D bounding boxes of a target object in images to facilitate the monitoring of the target object's whereabouts. For example, the target object is a vehicle, a pedestrian, etc. As shown in FIG. 1, the 3D bounding box reconstruction system 1 includes an image input device 11, a storage device 13 and a processing device 15, wherein the processing device 15 is coupled to the image input device 11 and the storage device 13.

The image input device 11 may include, but not limited to, a wired or wireless image transmission port. The image input device 11 is configured to receive images. These images may be static images captured in advance from a real-time stream or video. Alternatively, the image input device 11 may receive a real-time stream or video including images. For example, the image input device 11 may receive road images taken by a monocular camera installed on the road.

The storage device 13 may include, but not limited to, flash memory, hard disk drive (HDD), solid-state drive (SSD), dynamic random access memory (DRAM) or static random access memory (SRAM). The storage device 13 may store a transformation matrix. The transformation matrix may be associated with perspective transformation, and used to project an image to another viewing plane. In other words, the transformation matrix may be used to transform an image from a first perspective to a second perspective, and to transform the image from the second perspective back to the first perspective. For example, the first perspective and the second perspective are side perspective and top perspective respectively. Besides the transformation matrix, the storage device 13 may also store an object detection model trained in advance. The object detection model may be a convolutional neural network (CNN) model, particularly an instance segmentation model, such as Deep Snake model, but this disclosure is not limited to this.

The processing device 15 may include, but not limited to, a single processor or integration of microprocessors, such as central processing unit (CPU), graphic processing unit (GPU), etc. The processing device 15 is configured to use the data stored in the storage device 13 to detect the target object and reconstruct a 3D bounding box of the target object, and the steps performed by the processing device 15 are described later.

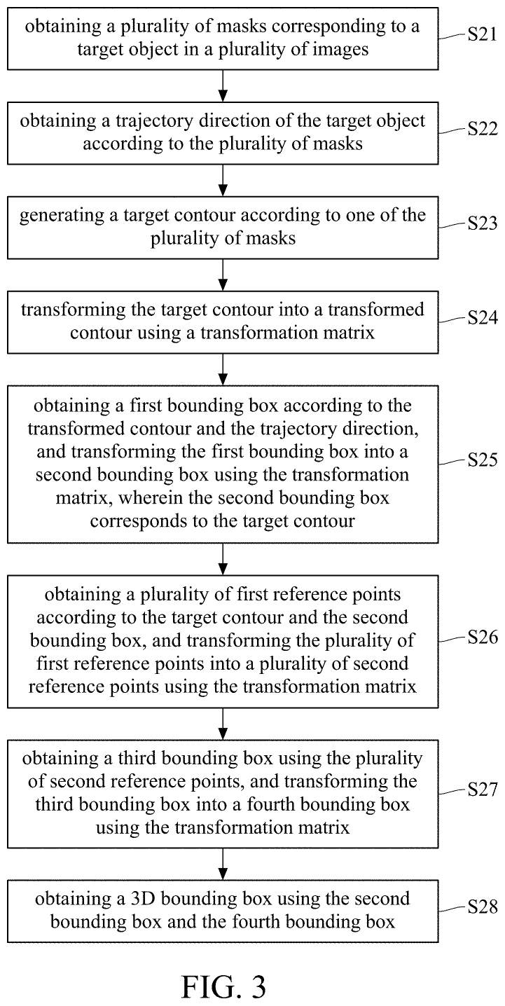

In some embodiments, before detecting the target object and reconstructing the 3D bounding box of the target object, the processing device 15 may obtain the transformation matrix according to a first image taken from the first perspective and a second image taken from the second perspective, and store the transformation matrix into the storage device 13. Please refer to FIG. 1 and FIG. 2, wherein FIG. 2 is a schematic diagram of image transformation according to an embodiment of this disclosure. In this embodiment, the image input device 11 may receive a first image I1 and a second image I2, with the first image I1 taken by a monocular camera installed on the road from a side perspective and the second image I2 taken by an aerial camera from a top perspective. The processing device 15 may perform calibration on the first image I1 and the second image I2 to obtain the transformation matrix A1. For example, the processing device 15 may obtain the coordinates of multiple characteristics, such as sidewalks, street lights, etc., on the first image I1 and the coordinates of the same characteristics on the second image I2, and use the coordinates of the characteristics on the two images to obtain a perspective transformation matrix as the transformation matrix A1.

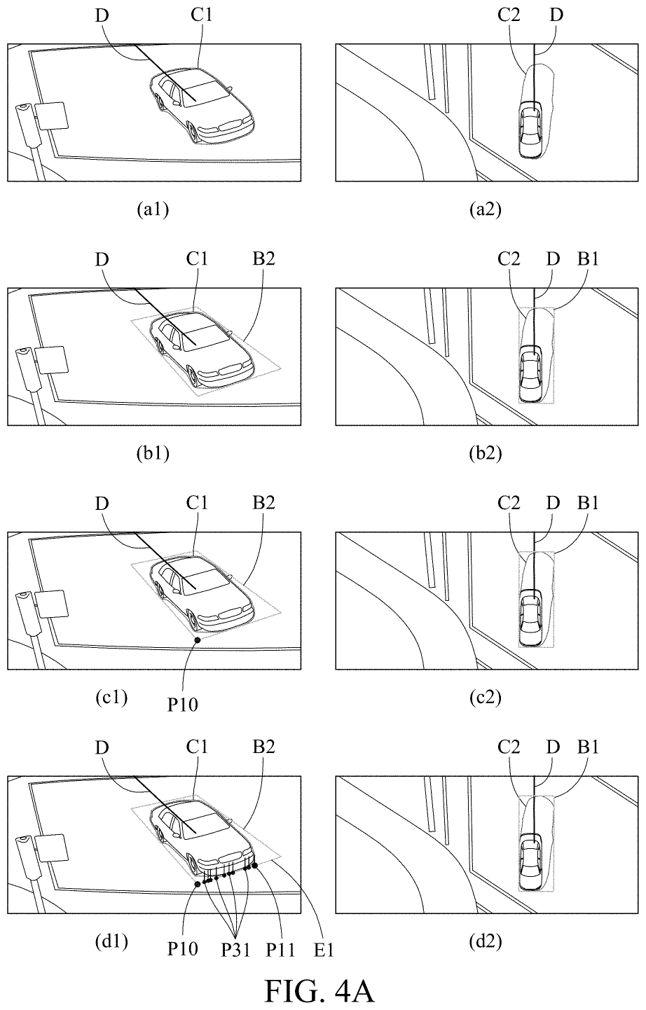

Please refer to FIG. 1 and FIG. 3, wherein FIG. 3 is a flow chart of a 3D bounding box reconstruction method according to an embodiment of this disclosure. The 3D bounding box reconstruction method may be performed for reconstructing 3D bounding boxes of a target object in images to facilitate the monitoring of the target object's whereabouts. For example, the target object is a vehicle, a pedestrian, etc.

As shown in FIG. 3, the 3D bounding box reconstruction method may include steps S21-S28. The 3D bounding box reconstruction method shown in FIG. 3 may be performed by the processing device 15 of the 3D bounding box reconstruction system 1, but not limited to this. For convenience of explanation, the steps of the 3D bounding box reconstruction method are exemplarily described as being performed by the processing device 15 as below.

In step S21, the processing device 15 obtains masks corresponding to the target object in images. More particularly, the processing device 15 may input the images into an object detection model and determine the target object in the images through the object detection model so as to obtain the masks corresponding to the target object. The object detection model may be a convolutional neural network (CNN) model that has been trained to detect the target object, particularly an instance segmentation model, such as Deep Snake model, but this disclosure is not limited to this.

In step S22, the processing device 15 obtains a trajectory direction of the target object according to the masks. In an implementation, the processing device 15 may process the masks using a single object tracking algorithm to obtain the trajectory direction of the target object. In another implementation, the processing device 15 may process the masks using a multiple object tracking algorithm for the situation that the masks include the masks corresponding to multiple target objects (i.e. multiple target objects are contained in the same image) to obtain the trajectory direction of each of the target objects. More particularly, the multiple object tracking algorithm may include: considering the centers of the masks to be the positions of the target objects; processing the obtained centers using Kalman filter to obtain an initial tracking result; processing the characteristic matrix of each of the masks using the Hungarian algorithm to adjust the initial tracking result; and obtaining the trajectory direction of each of the target objects from the tracking result. With the Hungarian algorithm, the tracking effect may be more perfect, and the problem of occlusion of the target objects may be solved.

In step S23, the processing device 15 generates a target contour according to one of the masks. More particularly, the processing device 15 may take the outer contour of one of the masks as the target contour. In steps S24-S28, the processing device 15 performs a series of transformations and processing on the target contour to obtain the 3D bounding box of the target object corresponding to the target contour. In particular, the processing device 15 may generate a target contour for each mask in each image and perform steps S24-S28 on the target contour to reconstruct the 3D bounding box of each target object on each image.

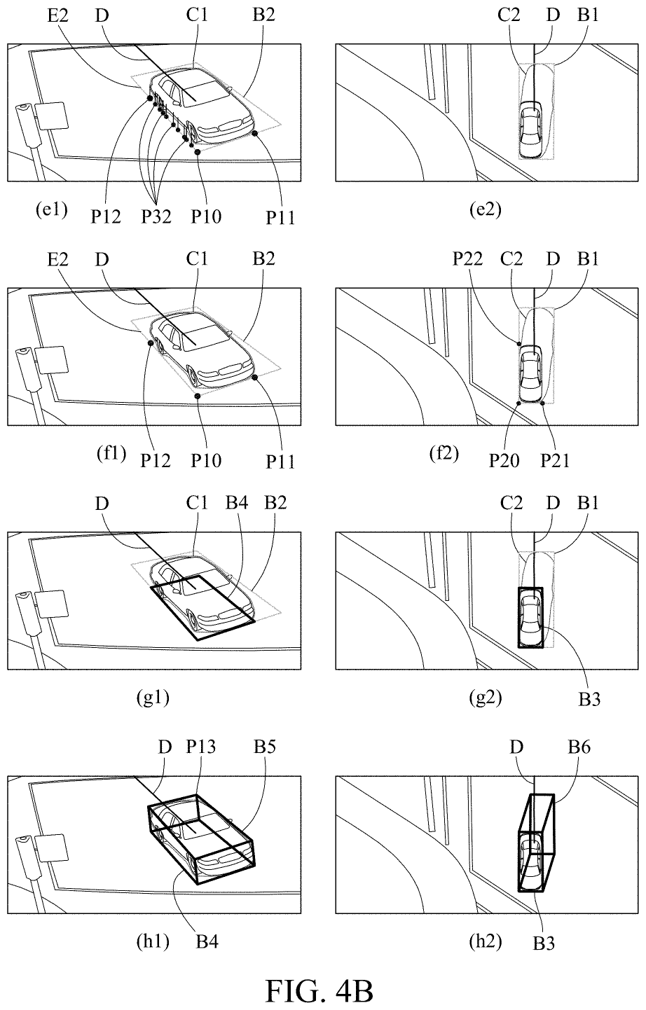

For understanding steps S24-S28 of the 3D bounding box reconstruction method in a better way, a vehicle is used as the target object in the following description, but the target object of the invention is not limited to this. Please refer to FIGS. 3, 4A and 4B, wherein FIGS. 4A and 4B are schematic diagrams of the computation of steps (a)-(h) of a 3D bounding box. Subfigures (a1)-(h1) show the computation result generated after steps (a)-(h) on a first perspective image respectively, and subfigures (a2)-(h2) show the computation result generated after steps (a)-(h) on a second perspective image respectively. The first perspective image corresponds to a side view image that contains the target object and is taken by a traffic camera, and the second perspective image corresponds to a top view image that is taken by an aerial camera. In particular, the second perspective image is used to exemplarily present the top view of the road, so it is not limited to be taken at the same time as the first perspective image. Alternatively, the second perspective image may be transformed from the first perspective image through the transformation matrix.

Steps (a)-(h) may be correspond to steps S24-S28 in FIG. 3. More particularly, step S24 may include step (a); step S25 may include step (b); step S26 may include steps (c)-(f); step S27 may include step (g); step S28 may include step (h). The execution of steps (a)-(h) are described in the following.

Step (a): transforming the target contour C1 into a transformed contour C2 using the transformation matrix. Step (a) may be regarded as mapping the target contour C1 from the first perspective image to the second perspective image to form a transformed contour C2. In particular, as shown in subfigure (a2), the size of the transformed contour C2 is obviously larger than that of ordinary vehicles, and the shape of the transformed contour C2 is distorted. It is because the target object in the image taken from the side perspective has a different size and shape due to the actual distance from the camera. Therefore, if the trajectory tracking is performed only using the vehicle contour, the obtained tracking result will have an error.

Step (b): obtaining a first bounding box B1 according to the transformed contour C2 and the trajectory direction D, and transforming the first bounding box B1 into a second bounding box B2 using the transformation matrix, wherein the second bounding box B2 corresponds to the target contour C1. More particularly, the implementation of obtaining the first bounding box B1 according to the transformed contour C2 and the trajectory direction D may include: obtaining two first line segments that are parallel to the trajectory direction D and tangent to the transformed contour C2; obtaining two second line segments that are perpendicular to the trajectory direction D and tangent to the transformed contour; and forming the first bounding box B1 using the two first line segments and the two second line segments. In other words, the first bounding box B1 is a quadrilateral formed by four tangent lines to the transformed contour C2, two of which are parallel to the trajectory direction D, and the other two are perpendicular to the trajectory direction D. The first bounding box B1 is transformed through the transformation matrix to be inversely mapped from the second perspective image to the first perspective image so as to form the second bounding box B2. Accordingly, the second bounding box B2 is also a quadrilateral.

Step (c): obtaining a corner point P10. In an implementation, the corner point P10 is a vertex closest to the origin of the camera coordinate system in the quadrilateral second bounding box B2. In another implementation, the corner point P10 is a vertex of which the y-coordinate in the image coordinate system is the smallest in the second bounding box B2, wherein the bottom left corner, horizontal direction and the vertical direction of the image are defined as the origin, x-axis direction and y-axis direction of the image coordinate system respectively.

Step (d): intersecting the target contour C1 along the first edge E1 of the second bounding box B2 in the vertical direction of the images to form first intersection points, projecting the first intersection points to the first edge E1 to form first points P31 respectively, and obtaining a first extreme point P11 that is a point with the longest distance from the corner point P10 among the first points P31.

Step (e): intersecting the target contour C1 along the second edge E2 of the second bounding box B2 in the vertical direction of the images to form second intersection points, projecting the second intersection points to the second edge E2 to form second points P32 respectively, and obtaining a second extreme point P12 that is a point with the longest distance from the corner point P10 among the second points P32.

The first edge E1 in step (d) and the second edge E2 in the step (e) as mentioned above are two sides of which the intersection is the corner point P10. The first extreme point P11 and the second extreme point P12 obtained in the two steps may be the length position and the width position of the target object. In particular, the first reference points mentioned in step S26 in FIG. 3 include the corner point P10, the first extreme point P11 and the second extreme point P12 obtained in steps (c)-(e) as mentioned above. It should be noted that the figure and the above description are not intended to limit the execution order of the steps (d) and (e).

Step (f): transforming the corner point P10, the first extreme point P11 and the second extreme point P12 using the transformation matrix to form the transformed corner point P20, the transformed first extreme point P21 and the transformed second extreme point P22 respectively. Step (f) may be regarded as mapping the corner point P10, the first extreme point P11 and the second extreme point P12 from the first perspective image to the second perspective image to form the transformed corner point P20, the transformed first extreme point P21 and the transformed second extreme point P22. In particular, the second reference points mentioned in step S26 in FIG. 3 include the transformed corner point P20, the transformed first extreme point P21 and the transformed second extreme point P22 obtained in step (f). In another embodiment, the transformations for obtaining the transformed corner point P20, the transformed first extreme point P21 and the transformed second extreme point P22 may be performed after obtaining the corner point P10, the first extreme point P11 and the second extreme point P12 in the above-mentioned steps (c)-(e) respectively.

Step (g): obtaining a third bounding box B3 using the transformed corner point P20, the transformed first extreme point P21 and the transformed second extreme point P22, and transforming the third bounding box B3 into a fourth bounding box B4 using the transformation matrix. More particularly, the implementation of obtaining the third bounding box B3 using the transformed corner point P20, the transformed first extreme point P21 and the transformed second extreme point P22 may include: obtaining a first line segment that connects the transformed corner point P20 and the transformed first extreme point P21; obtaining a second line segment that connects the transformed corner point P20 and the transformed second extreme point P22; obtaining a third line segment that connects to the transformed first extreme point P21 and is parallel to the first line segment; obtaining a fourth line segment that connects to the transformed second extreme point P22 and is parallel to the second line segment; and forming the third bounding box B2 using the first to fourth line segments. Then, the third bounding box B3 is transformed through the transformation matrix to be inversely mapped from the second perspective image to the first perspective image so as to form the fourth bounding box B4.

Step (h): obtaining a 3D bounding box using the second bounding box B2 and the fourth bounding box B4. More particularly, it can be seen from the above steps that the second bounding box B2 and the fourth bounding box B4 are each composed of a quadrilateral. In an implementation, step (h) may include: generating a quadrilateral composing a fifth bounding box B5, wherein a vertex P13 farthest from the origin of the camera coordinate system in the fifth bounding box B5 is identical to a vertex farthest from the origin of the camera coordinate system in the second bounding box B2, and the quadrilateral composing the fifth bounding box B5 is identical to the quadrilateral composing the fourth bounding box B4; and using the fourth bounding box B4 as the bottom of the 3D bounding box, and using the fifth bounding box B5 as the top of the 3D bounding box. In another implementation, the vertex P13 is a vertex of which the y-coordinate in the image coordinate system is the largest in the fifth bounding box B5 and its image coordinates are the same as those of a vertex of which the y-coordinate in the image coordinate system is the largest in the second bounding box B2, wherein the bottom left corner, horizontal direction and the vertical direction of the image are defined as the origin, x-axis direction and y-axis direction of the image coordinate system respectively.

In some embodiments, besides obtaining the 3D bounding box from the first perspective, step (h) may further includes obtaining a 3D bounding box from the second perspective. In an implementation, the 3D bounding box from the second perspective is obtained using the first bounding box B1 and the third bounding box B3. The execution of obtaining the 3D bounding box from the second perspective is in the same way as that of obtaining the 3D bounding box from the first perspective, so it is not repeated here. In another implementation, the fifth bounding box B5 may be further transformed into the sixth bounding box B6 as the top of the 3D bounding box from the second perspective, and the third bounding box B3 is used as the bottom of the 3D bounding box from the second perspective.

For ease of understanding, FIGS. 4A and 4B exemplarily show the computation process of reconstructing the 3D bounding box of a single target object. However, in other embodiments, the 3D bounding box reconstruction system/method may perform the 3D bounding box reconstruction steps described in the above embodiments on multiple target objects in the image at the same time or one by one.

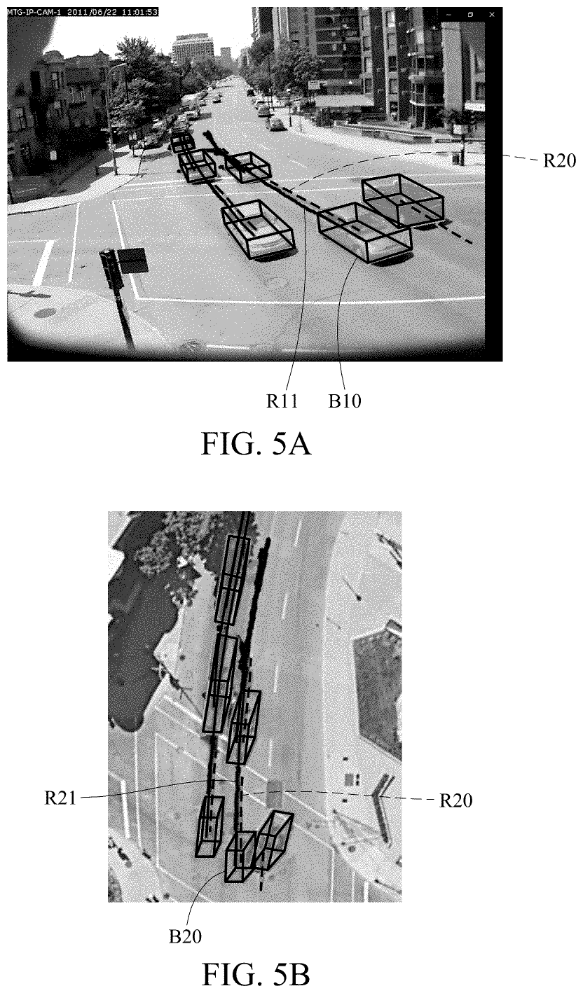

In some embodiments, after obtaining the 3D bounding box of the target object, the 3D bounding box reconstruction system/method may further apply the 3D bounding box to trajectory tracking of the target object. More particularly, the geometric center of the bottom of the 3D bounding box may be regarded as the position of the target object. Please refer to FIGS. 5A and 5B, schematic diagrams of the application of a 3D bounding box reconstruction method according to an embodiment of this disclosure. FIGS. 5A and 5B show the 3D bounding boxes of target objects and the moving paths of the target objects reconstructed using the 3D bounding boxes on the first perspective image and the second perspective image respectively. The first perspective image corresponds to a side view image that contains the target object and is taken by a traffic camera, and the second perspective image corresponds to a top view image that is taken by an aerial camera. In particular, the second perspective image is used to exemplarily present the top view of the road, so it is not limited to be taken at the same time as the first perspective image. Alternatively, the second perspective image may be transformed from the first perspective image through the transformation matrix. As shown in FIG. 5A/5B, the moving path R11/R21 is reconstructed using the geometric center of the bottom of the 3D bounding box B10/B20 as the position of the target object, so it may be more accurate than the moving path R10/R20 generated using the original contour of the target object.

In some embodiments, the 3D bounding box reconstruction method described in the above embodiments may be included in a non-transitory computer readable medium, such as an optical disc, a flash drive, a memory card, a hard disk of a cloud server, etc., in the form of at least one computer executable procedure. When said at least one computer executable procedure is executed by the processor of a computer, the 3D bounding box reconstruction method described in the above embodiments is implemented.

In view of the above description, the 3D bounding box reconstruction system, the 3D bounding box reconstruction method and the non-transitory computer readable medium in this disclosure may perform specific image transformation and processing steps on the contour corresponding to the target object to create a 3D bounding box of a target object, without the need to input the contour into a neural network model for computation, so they may have a lower computational complexity and a higher computational speed in comparison with purely using a neural network model to create a 3D bounding box. The 3D bounding box reconstruction system, the 3D bounding box reconstruction method and the non-transitory computer readable medium in this disclosure may reconstruct a 3D bounding box of a target object for correcting the position of the center of the target object so as to obtain a more accurate target object trajectory direction. In this way, the system, method and non-transitory computer readable medium in this disclosure may achieve 3D reconstruction of traffic flows in different directions, and particularly be applied to vehicle monitoring in complex road environments such as intersections or roundabouts and not limited to preset road environments with a fixed trajectory direction (such as highways) Also, since a more accurate center may be obtained, the system, method and non-transitory computer readable medium in this disclosure may have a good performance in the application of vehicle speed monitoring. Moreover, in comparison with a 2D bounding box, a 3D bounding box may show the actual scope of the target object, so the system, method and non-transitory computer readable medium in this disclosure may have a good performance in the application of judging traffic incidents or states.

What is claimed is:

1. A 3D bounding box reconstruction method, comprising:
obtaining a plurality of masks corresponding to a target object in a plurality of images;
obtaining a trajectory direction of the target object according to the plurality of masks;
generating a target contour according to one of the plurality of masks;
transforming the target contour into a transformed contour using a transformation matrix;
obtaining a first bounding box according to the transformed contour and the trajectory direction, and transforming the first bounding box into a second bounding box using the transformation matrix, wherein the second bounding box corresponds to the target contour;
obtaining a plurality of first reference points according to the target contour and the second bounding box, and transforming the plurality of first reference points into a plurality of second reference points using the transformation matrix;
obtaining a third bounding box using the plurality of second reference points, and transforming the third bounding box into a fourth bounding box using the transformation matrix; and
obtaining a 3D bounding box using the second bounding box and the fourth bounding box.

2. The 3D bounding box reconstruction method according to claim 1, wherein obtaining the first bounding box according to the transformed contour and the trajectory direction comprises:
obtaining two first line segments that are parallel to the trajectory direction and tangent to the transformed contour;
obtaining two second line segments that are perpendicular to the trajectory direction and tangent to the transformed contour; and
forming the first bounding box using the two first line segments and the two second line segments.

3. The 3D bounding box reconstruction method according to claim 1, wherein the second bounding box is a quadrilateral, and obtaining the plurality of first reference points according to the target contour and the second bounding box comprises:
obtaining a corner point that is a vertex closest to an origin of a camera coordinate system, and is an intersection of a first edge and a second edge of the quadrilateral;
intersecting the target contour along the first edge in a vertical direction of the plurality of images to form a plurality of first intersection points, projecting the plurality of first intersection points to the first edge to form a plurality of first points respectively, and obtaining a first extreme point that is a point with a longest distance from the corner point among the plurality of first points; and
intersecting the target contour along the second edge in the vertical direction of the plurality of images to form a plurality of second intersection points, projecting the plurality of second intersection points to the second edge to form a plurality of second points respectively, and obtaining a second extreme point that is a point with a longest distance from the corner point among the plurality of second points;
wherein the first reference points comprise the corner point, the first extreme point and the second extreme point.

4. The 3D bounding box reconstruction method according to claim 3, wherein the second reference points comprise a transformed corner point transformed from the corner point, a transformed first extreme point transformed from the first extreme point and a transformed second extreme point transformed from the second extreme point, and obtaining the third bounding box using the plurality of second reference points comprises:
forming the third bounding box using the transformed corner point, the transformed first extreme point and the transformed second extreme point.

5. The 3D bounding box reconstruction method according to claim 1, wherein each of the second bounding box and the fourth bounding box is composed of a quadrilateral, and obtaining the 3D bounding box using the second bounding box and the fourth bounding box comprises:
generating a quadrilateral composing a fifth bounding box, wherein a vertex farthest from an origin of a camera coordinate system in the fifth bounding box is identical to a vertex farthest from the origin of the camera coordinate system in the second bounding box, and the quadrilateral composing the fifth bounding box is identical to the quadrilateral composing the fourth bounding box; and
using the fourth bounding box as a bottom of the 3D bounding box, and using the fifth bounding box as a top of the 3D bounding box.

6. The 3D bounding box reconstruction method according to claim 1, wherein the plurality of masks are obtained by determining the target object in the plurality of images through an object detection model.

7. The 3D bounding box reconstruction method according to claim 1, further comprising:
performing calibration on a first image taken from a first perspective and a second image taken from a second perspective to obtain the transformation matrix.

8. The 3D bounding box reconstruction method according to claim 1, wherein the 3D bounding box obtained using the second bounding box and the fourth bounding box is a 3D bounding box from a first perspective, and the 3D bounding box reconstruction method further comprises:
obtaining a 3D bounding box from a second perspective using the first bounding box and the third bounding box.

9. A 3D bounding box reconstruction system, comprising:
an image input device, configured to receive a plurality of images;
a storage device, configured to store a transformation matrix;
a processing device coupled to the image input device and the storage device, wherein the processing device is configured to perform a plurality of steps comprising:
obtaining a plurality of masks corresponding to a target object in a plurality of images;
obtaining a trajectory direction of the target object according to the plurality of masks;
generating a target contour according to one of the plurality of masks;
transforming the target contour into a transformed contour using the transformation matrix;
obtaining a first bounding box according to the transformed contour and the trajectory direction, and transforming the first bounding box into a second bounding box using the transformation matrix, wherein the second bounding box corresponds to the target contour;
obtaining a plurality of first reference points according to the target contour and the second bounding box, and transforming the plurality of first reference points into a plurality of second reference points using the transformation matrix;
obtaining a third bounding box using the plurality of second reference points, and transforming the third bounding box into a fourth bounding box using the transformation matrix; and
obtaining a 3D bounding box using the second bounding box and the fourth bounding box.

10. The 3D bounding box reconstruction system according to claim 9, wherein the processing device is configured to obtain two first line segments and two second line segments, and form the first bounding box using the two first line segments and the two second line segments, wherein the two first line segments are parallel to the trajectory direction and tangent to the transformed contour, and the two second line segments are perpendicular to the trajectory direction and tangent to the transformed contour.

11. The 3D bounding box reconstruction system according to claim 9, wherein the second bounding box is a quadrilateral, and the processing device is configured for:
obtaining a corner point that is a vertex closest to an origin of a camera coordinate system, and is an intersection of a first edge and a second edge of the quadrilateral;
intersecting the target contour along the first edge in a vertical direction of the plurality of images to form a plurality of first intersection points, projecting the plurality of first intersection points to the first edge to form a plurality of first points respectively, and obtaining a first extreme point that is a point with a longest distance from the corner point among the plurality of first points; and
intersecting the target contour along the second edge in the vertical direction of the plurality of images to form a plurality of second intersection points, projecting the plurality of second intersection points to the second edge to form a plurality of second points respectively, and obtaining a second extreme point that is a point with a longest distance from the corner point among the plurality of second points;
wherein the first reference points comprise the corner point, the first extreme point and the second extreme point.

12. The 3D bounding box reconstruction system according to claim 11, wherein the second reference points comprise a transformed corner point transformed from the corner point, a transformed first extreme point transformed from the first extreme point and a transformed second extreme point transformed from the second extreme point, and the processing device is configured to form the third bounding box using the transformed corner point, the transformed first extreme point and the transformed second extreme point.

13. The 3D bounding box reconstruction system according to claim 9, wherein each of the second bounding box and the fourth bounding box is composed of a quadrilateral, and the processing device is configured to generate a quadrilateral composing a fifth bounding box, using the fourth bounding box as a bottom of the 3D bounding box, and using the fifth bounding box as a top of the 3D bounding box, wherein a vertex farthest from an origin of a camera coordinate system in the fifth bounding box is identical to a vertex farthest from the origin of the camera coordinate system in the second bounding box, and the quadrilateral composing the fifth bounding box is identical to the quadrilateral composing the fourth bounding box.

14. The 3D bounding box reconstruction system according to claim 9, wherein the storage device further stores an object detection model, and the processing device is further configured to determine the target object in the plurality of images through the object detection model to obtain the plurality of masks of the target object.

15. The 3D bounding box reconstruction system according to claim 9, wherein the image input device is further configured to receive a first image taken from a first perspective and a second image taken from a second perspective, and the processing device is further configured to perform calibration on the first image and the second image to obtain the transformation matrix.

16. The 3D bounding box reconstruction system according to claim 9, wherein the 3D bounding box obtained using the second bounding box and the fourth bounding box is a 3D bounding box from a first perspective, and the processing device is further configured to obtain a 3D bounding box from a second perspective using the first bounding box and the third bounding box.

17. A non-transitory computer readable medium, comprising at least one computer executable procedure, wherein a plurality of steps are performed when said at least one computer executable procedure is executed by a processor, and the plurality of steps comprise:
obtaining a plurality of masks corresponding to a target object in a plurality of images;
obtaining a trajectory direction of the target object according to the plurality of masks;
generating a target contour according to one of the plurality of masks;
transforming the target contour into a transformed contour using a transformation matrix;
obtaining a first bounding box according to the transformed contour and the trajectory direction, and transforming the first bounding box into a second bounding box using the transformation matrix, wherein the second bounding box corresponds to the target contour;
obtaining a plurality of first reference points according to the target contour and the second bounding box, and transforming the plurality of first reference points into a plurality of second reference points using the transformation matrix;
obtaining a third bounding box using the plurality of second reference points, and transforming the third bounding box into a fourth bounding box using the transformation matrix; and
obtaining a 3D bounding box using the second bounding box and the fourth bounding box.
